(19) United States
(12) Patent Application Publication
(10) Pub. No.: US 2013/0048437 A1
(43) Pub. Date: Feb. 28, 2013

(54) "ROLLER-EQUIPPED GUIDE"

(71) Applicant: Ulrich Graf, Donauworth (DE)

(72) Inventor: Ulrich Graf, Donauworth (DE)

(73) Assignee: GEDA-DECHENTREITER GMBH & CO. KG, Asbach-Baumenheim (DE)

(21) Appl. No.: 13/572,969

(22) Filed: Aug. 13, 2012

(30) Foreign Application Priority Data
Aug. 26, 2011 (DE) 20 2011 105 039.8

(51) Int. Cl. B66B 7/04

(52) U.S. Cl. 187/410

(57) ABSTRACT

A roller-equipped guide for a travelling element of a lift or hoist, which travelling element is guided against a guiding system, having at least one rotatably mounted guide roller. The roller-equipped guide is connected to a joint by the guide roller pivotable on at least one axis.

This application claims priority to German Patent Application No. DE 20 2011 105 039.8 filed Aug. 26, 2011.

### BACKGROUND OF THE INVENTION

1. Field of the Invention

The invention relates to a roller-equipped guide for a travelling element, and in particular a car, of a lift or hoist and in particular of an external hoist such for example as one used as a builder's hoist, which travelling element is guided against a guiding system.

2. Description of Related Art

External hoists are used for example on building sites in the field of above-ground construction to transport people and materials to the upper storeys of the building which is being built or renovated.

External hoists of this kind regularly have a guiding system which is fixed to one of the walls of the building and which thus extends in the vertical direction. The guiding system consists of one or two towers to which a car is attached in such a way as to be displaceable. The car is used to hold the people or goods to be moved.

The towers thus serve to guide the movement of the car, in which case they may even constitute a part of the drive train. As a rule, at least one of the towers is provided for this purpose with a rack which extends in the direction defined by the longitudinal axis of the guiding system and in which a pinion belonging to an electrical travel drive engages. In hoists or lifts of this kind the travel drive is thus accommodated in the region of the car and is thus moved with the latter.

The guiding of the car on the guiding system is accomplished by means of a plurality of roller-equipped guides which are supported against a guide rail belonging to the guiding system. This guide rail is in many cases formed to be circular in cross-section (what is referred to as a circular guide), with the individual guide rollers of the roller-equipped guides being provided with a concave running surface corresponding to the circular cross-section.

A problem which arises from the roller-equipped guides and the guide rail being of this form lies in the fact that it is not possible for the guide rails to move relative to the roller-equipped guides in the transverse direction (of the guide rails). However, the path followed by the guide rails is usually not entirely straight, a particular reason for this being that the guiding system is plugged together on site from a plurality of relatively short sections and for reasons of cost the sections of the guiding system are produced to relatively wide tolerances. The guide rollers thus have to follow guide rails whose path is not straight, in which case it may be necessary for this purpose, depending on the position of the given guide roller against the guide rail, for the guide roller to move in the direction defined by its axis of rotation. To make this possible, provision may be made for the guide rollers to be provided with a mounting (for rotation) which at the same time allows the guide roller to be axially displaceable in the mounting belonging to the roller-equipped guide. However, the design of a mounting of this kind involves considerable cost and complication, as a result of which there is then an increase in the cost of the lift or hoist.

To avoid this problem, the possibility exists of performing the guidance of the car by means of what are referred to as parallel guiding systems, where the guide rails are rectangular in cross-section and have plane guiding surfaces along which guide rollers roll by means of plane running surfaces. This combination allows movement of the guide roller relative to the guide rail in its transverse direction. It is possible to dispense in this way with a complicated and costly mounting (for rotation) for the guide roller which allows mobility on the longitudinal axis. It is however a disadvantage that, due to the relative movement being performed by sliding, increased wear occurs to the guide rollers, which is countered by making the guide rollers of metal. However, an adverse characteristic of metal guide rollers which roll on a metal guide rail is that the ride they give is a comparatively uncomfortable one and in particular that they make a great deal of noise.

### SUMMARY OF THE INVENTION

Bearing in mind the problems and deficiencies of the prior art, it is therefore an object of the present invention to provide an improved roller-equipped guide for a lift or hoist. What should in particular be specified is a roller-equipped guide of simple construction which is suitable for use with a circular guide.

It is another object of the present invention to provide a roller-equipped guide for a travelling element of a lift or hoist, the travelling element being guided against a guiding system, the roller-equipped guide comprising at least one rotatably mounted guide roller connected to a joint and pivotable on at least one axis. The at least one rotatably mounted guide roller may be pivotable on an axis which extends in or parallel to the radial plane of the guide roller. The joint may comprise a ball-joint.

The guide roller may be connected to the joint via a cantilever member.

Two guide rollers may be connected together by a yoke, the joint being arranged at a first end of the cantilever member, which latter is connected by its second end to the yoke in a region situated between the two guide rollers. The guide rollers may include a curved running surface, which may be of a plastics material.

The roller-equipped guide may include an adjustment for setting the distance between a running surface of the guide rollers and the guiding system. The adjustment may comprise an eccentric rotary joint, and may include a threaded spindle.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is an isometric view of a lift or hoist having roller-equipped guides according to the invention which take the form of a first embodiment.

FIG. 2 is a rear view of the lift or hoist shown in FIG. 1.

FIG. 3 is a first, enlarged, detail view of the lift or hoist shown in FIGS. 1 and 2.

FIG. 4 is an isometric view of a second, enlarged, detail of the lift or hoist shown in FIGS. 1 and 2.

FIG. 5 is a cross-section through a roller-equipped guide of the lift or hoist shown in FIGS. 1 through 4.

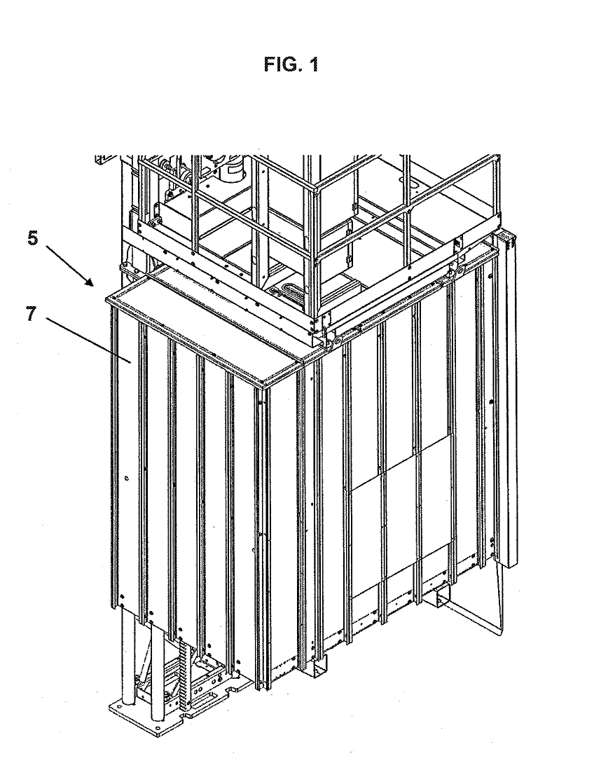

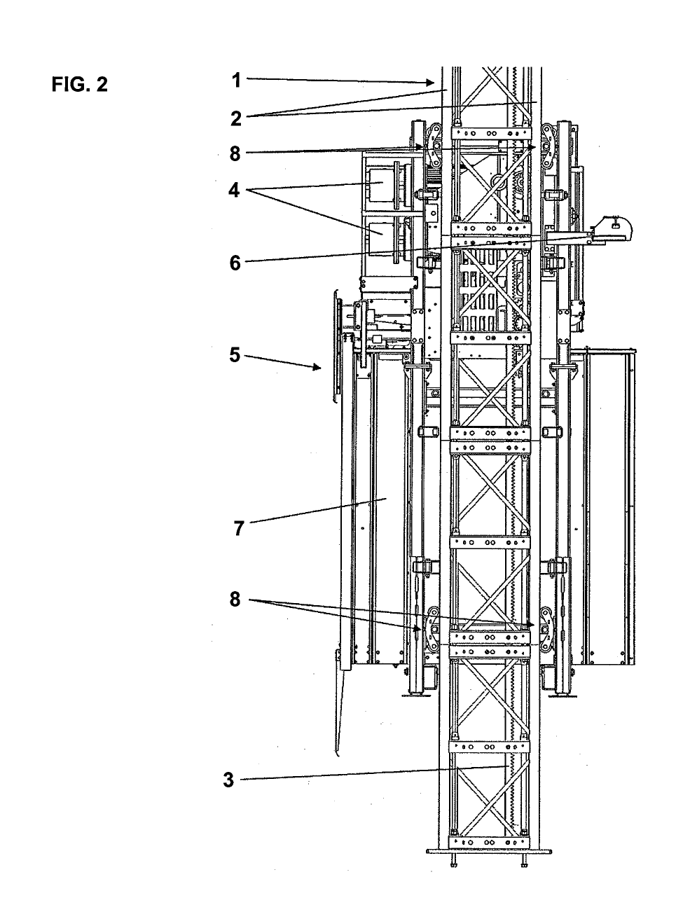

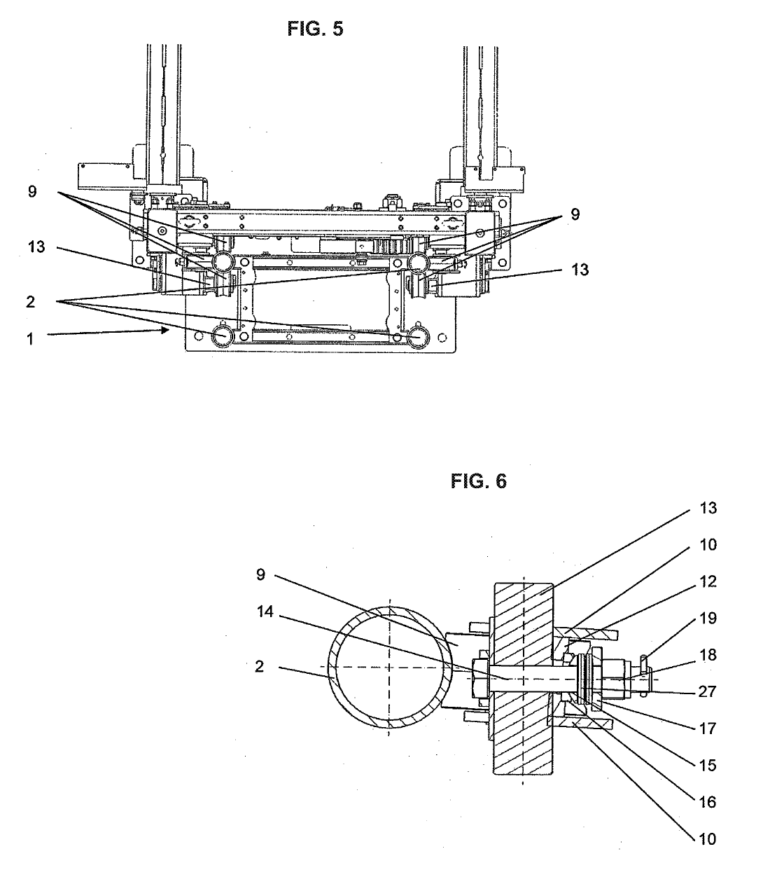

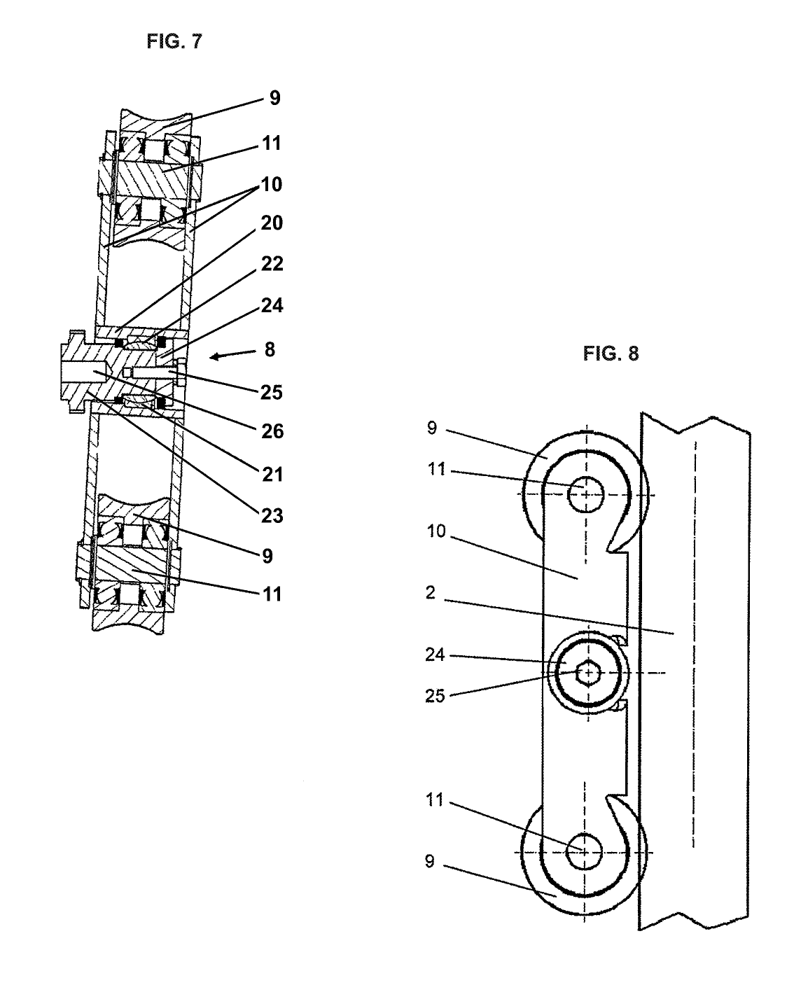

FIGS. 1 through 5 show an external lift or hoist such as is often used for renovating buildings.

FIG. 6 is a plan view of part of the lift or hoist shown in FIGS. 1 through 4.

FIG. 7 is a longitudinal section through a second embodiment of roller-equipped guide according to the invention.

FIG. 8 is a view from the side of the roller-equipped guide shown in FIG. 7.

### DESCRIPTION OF THE PREFERRED EMBODIMENT(S)

In describing the preferred embodiment of the present invention, reference will be made herein to FIGS. 1-8 of the drawings in which like numerals refer to like features of the invention.

A roller-equipped guide of the generic kind having at least one guide roller, for a travelling element such in particular as a car or even a cable-drawn trolley for example, which travelling element is guided against a guiding system of a lift or hoist, is characterized in accordance with the invention in that the guide roller is connected to a joint by means of which the guide roller is pivotable on at least one axis.

Because of the pivotability according to the invention of the guide roller, a possibility is created, in a structurally simple way, of a simply mounted guide roller being so designed that it will follow the guiding system if the latter does not follow a straight path in the transverse direction.

Because the guide roller(s) of roller-equipped guides of the generic kind generally bear against the guiding system in such a way that the (central) radial plane of the guide rollers is arranged to be perpendicular to the contacted surface of the guiding system, provision is made in a preferred embodiment of roller-equipped guide according to the invention for the guide roller(s) to be pivotable by means of the joint on at least one axis which lies in or parallel to this radial plane of the guide roller.

Provision may preferably be made for the joint to take the form of a ball-joint, whereby pivoting on a plurality of axes is made possible in a structurally simple way.

Provision may also be made for the guide roller(s) to be connected to the joint via a cantilever member. This embodiment has the advantage that the distance between the center of rotation and the guide roller(s) is increased, which means that a defined sideways movement of the guide roller(s) involves only a relatively small inclination.

In a preferred embodiment of a roller-equipped guide according to the invention of this kind, provision is made for the latter to have (at least) two guide rollers which are connected together by a yoke, the joint being arranged at a first end of the cantilever member, which latter is connected by its second end to the yoke in a region of the yoke situated between the two guide rollers.

In an alternative embodiment, provision is made for the roller-equipped guide to comprise (at least) two guide rollers which are connected together by a yoke, the joint being connected to the yoke in a region of the yoke which is situated between the two guide rollers.

The invention is suitable in particular for improving roller-equipped guides whose guide rollers have curved running surfaces which are thus combined in particular with what are referred to as circular guides of a lift or hoist. The running surfaces are in particular of a concave form in this case, thus enabling them to be combined with conventional circular guides.

Because of the precise guidance of the guide roller(s) on the guiding system which is achieved in accordance with the invention, the guide roller(s) employed may readily be ones of which at least the running surfaces are formed from plastics material. In this case, simply a part of the given guide roller which forms the running surface may be formed from plastic material or the entire guide roller may be so formed.

In a further preferred embodiment of roller-equipped guide according to the invention, the latter has an adjusting arrangement by which the distance between a running surface of the individual guide rollers and the guiding system can be set. This adjustability of the guide rollers may in particular be in a direction which lies in or parallel to the central radial plane of the guide roller. This creates a possibility of the individual guide rollers being set individually and caused to bear against the guide rail as exactly as possible.

The adjusting arrangement may preferably comprise an eccentric rotary joint which, due to its being eccentrically mounted in rotation, converts a relative rotation of two elements into a movement of the said elements in translation.

The adjusting arrangement may even be a threaded spindle by means of which a setting of distance can be performed in a structurally simple way.

The lift or hoist comprises a guiding system 1 which is of a rectangular basic shape in cross-section. The guiding system is formed by a total of four guide rails 2 which are arranged at the corners of the rectangular cross-section and which are connected together by a plurality of struts extending horizontally and diagonally. The cross-section of the guide rails 2 is circular.

The guiding system 1 also comprises a rack 3 which extends parallel to the axis of the guiding system 1. Engaging in this rack 3 are the drive pinions of a total of two travel drives 4 which are arranged on a roof structure of a car 5 of the lift or hoist. The travel drives 4 of the car 5 are thus moved with the car 5, the electrical energy required for the operation of the travel drives 4 being fed in via a co-travelling drum cable 6. The roof structure of the car 5 is solidly connected to a car enclosure 7 of which the boundaries are four outer walls and a floor member and which serves to hold the people to be moved or the goods to be moved.

The car 5 is guided in the guiding system 1 of the lift or hoist, for which purpose there are provided a plurality of roller-equipped guides 8 whose guide rollers 9 roll on the two guide rails 2 of the guiding system 1 which are adjacent to the car 5. The roller-equipped guides 8 are connected to the car 5 at a plurality of points.

Each of the roller-equipped guides 8 comprises two guide rollers 9 which are arranged at a distance from one another and which are each rotatably arranged inside a yoke. Each yoke comprises two outer plates 10 in each end of which is provided a through-opening which is used to receive the mounting shafts 11 of the guide rollers 9. The two outer plates 10 are in each case connected together by a transverse plate 12 to which is also attached a fastening pin 13 by which the given roller-equipped guide 8 is connected to the car 5.

The connection of the fastening pin 13 to the transverse plate 12 of the yoke of the given roller-equipped guide 8 is accomplished by a bolted joint which at the same time performs the function of a threaded spindle by means of which the distance between the running surfaces of the guide rollers 9 and the given guide rail 2 can be set. The details of this joint can be seen from the cross-section shown in FIG. 6. It can be seen there that the fastening pin 13 is provided with a through-opening through which a threaded pin 14 (a conventional hexagon-head bolt) projects. A further part of the threaded pin 14 projects through a through-opening in the transverse plate 12 and through a ball joint. That section of the roller-equipped guide 8 which comprises the guide rollers 9 and the yoke can be pivoted by the ball joint, as shown in FIG. 6. When this happens an angle of inclination is set between the longitudinal axis of the threaded pin 14 and the (central) radial plane(s) of the two guide rollers 9. The main purpose of this is to compensate for a transverse offset of the guide rollers 9 relative to their respective guide rail 2 such as may result locally from, in particular, a non-straight path followed by the guiding system which is assembled from individual sections.

The ball-joint comprises a ball member 15 having a convex mating face which is mounted to slide in a mating socket 16 of a concave form. The mating socket 16 is connected to the transverse plate 12 of the yoke. The ball member 15 enables that part of the roller-equipped guide 8 which comprises the guide rollers 9 and the yoke to pivot on any desired axis, a limit being set to its deflection by the clearance of the threaded pin 14 in the through-opening in the transverse plate 12. At the rear, i.e. on the side remote from the convex surface, the ball member 15 is supported by a stack 27 of disc springs and a washer 17 against a nut 18 which is screwed onto the threaded pin 14. A securing pin 19 which projects through a transverse opening in the threaded pin 14 prevents the nut 18 from become detached from the threaded pin 14.

The distance between the fastening pin 13 and that part of the roller-equipped guide 8 which comprises the guide rollers 9 and the yoke sets itself in operation under the existing load and it can be altered by displacing the nut 18 on the threaded pin. The purpose of this is to enable the running surfaces of the guide rollers 9 to be caused to bear against the guide rails 2 without any play when the car is being fitted.

The stack 27 of disc springs ensures that the guide rollers bear against the given guide rail under spring loading, which makes it possible to ensure that the guide rollers are always in contact with the guide rails while the car 5 is moving, by which means it is possible to obtain good, quiet running by the car 5. Such roller-equipped guides may thus be used particularly where alternating loads would result in contact being lost between the guide rollers and the guide rail.

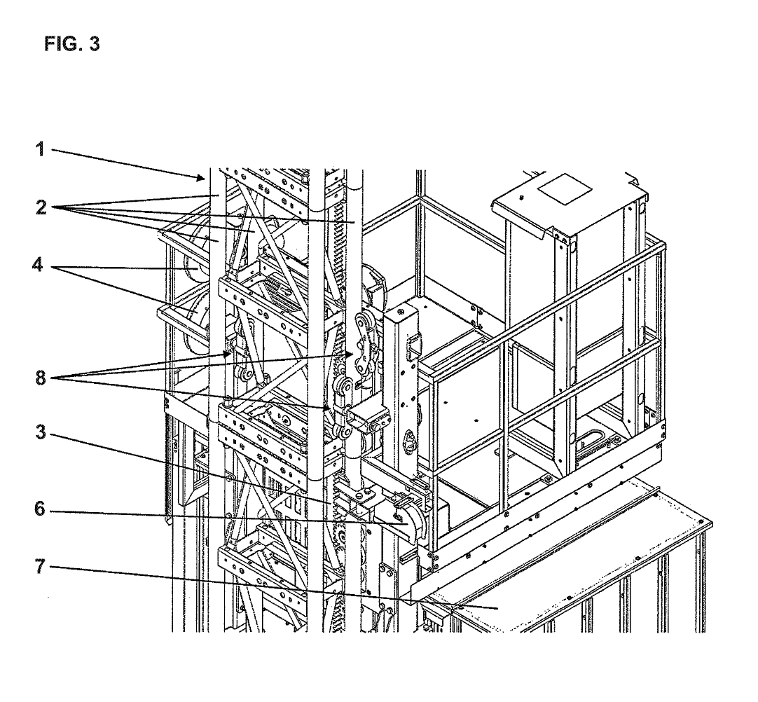

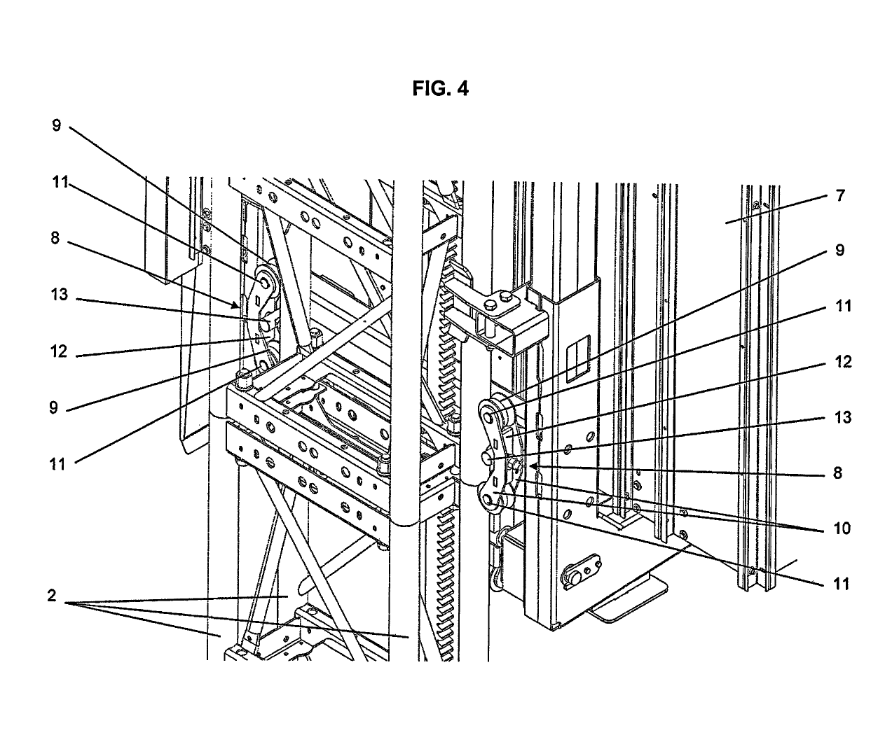

The car is provided both in the region of the roof structure (see FIG. 3) and in the region of the bottom end of the car enclosure (see FIG. 4) with, at each of these points, a total of six roller-equipped guides 8, of which three bear against each of the corresponding guide rails 2 with an offset from one another both in the longitudinal direction (of the guide) and in the circumferential direction (by 90° and 180° respectively).

Shown in FIGS. 7 and 8 is an alternative embodiment of roller-equipped guide 8 according to the invention such as may be used on the lift or hoist shown in FIGS. 1 to 5 in place of the roller-equipped guide 8 shown in those figures.

This roller-equipped guide 8 likewise comprises two guide rollers 9 which are connected together by a yoke. The yoke comprises two outer plates 10 which are each provided at their ends with through-openings which are used to hold mounting shafts 11 of the guide rollers 9. Centrally between the two guide rollers 9, the yoke is connected to a ball-joint which allows the yoke holding the guide rollers 9 to pivot. The ball joint comprises a tubular joint housing 20 which extends through through-openings in the two outer plates 10 of the yoke and which is connected thereto. Arranged in a part of the interior of this joint housing 20 is a first joint-ring 21 whose inside face is of a concave form. An outside face of convex form of a second joint-ring 22 slides on this concave inside face. The second joint-ring 22 is fixed to a joint-held body 23 and is fixed in position by a joint-cap 24 which is connected to the joint-held body 23 by a screwed connector 25.

Provided at the opposite end of the joint-held body 23 from the joint cap 24 is an eccentrically arranged threaded bore 26. This threaded bore 26 is used to bolt the roller-equipped guide 8 to the car 5. The eccentricity of the threaded bore 26 makes it possible (by an appropriate orientation in rotation of the joint-held body followed by the tightening of the screwed connector) for the distance between the guide rollers 9 and their particular rail 2 to be set (and fixed by tightening a bolt which engages in the threaded bore), and thus makes it possible to ensure that each of the guide rollers 9 of the roller-equipped guides 8 bears against the given guide rail with as great a freedom from play as possible. The eccentric threaded bore is thus part of an eccentric rotary joint.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A roller-equipped guide for a travelling element of a lift or hoist, said travelling element being guided against a guiding system, said roller-equipped guide comprising at least one rotatably mounted guide roller connected to a joint and pivotable on at least one axis.

2. The roller-equipped guide of claim 1 including the at least one rotatably mounted guide roller pivotable on an axis which extends in or parallel to the radial plane of the guide roller.

3. The roller-equipped guide of claim 1, wherein the joint comprises a ball-joint.

4. The roller-equipped guide of claim 1, wherein the guide roller is connected to the joint via a cantilever member.

5. The roller-equipped guide of claim 4 including two guide rollers connected together by a yoke, the joint being arranged at a first end of the cantilever member, which latter is connected by its second end to the yoke in a region situated between the two guide rollers.

6. The roller-equipped guide of claim 1 comprising two guide rollers which are connected together by a yoke, the joint being arranged on the yoke between the two guide rollers.

7. The roller-equipped guide of claim 1, wherein the guide rollers include a curved running surface.

8. The roller-equipped guide of claim 1, wherein the guide rollers include a running surface of plastics material.

9. The roller-equipped guide of claim 1 including an adjustment for setting the distance between a running surface of the guide rollers and the guiding system.

10. The roller-equipped guide of claim 9, wherein the adjustment comprises an eccentric rotary joint.

11. The roller-equipped guide of claim 9, wherein the adjustment includes a threaded spindle.

12. The roller-equipped guide of claim 2, wherein the joint comprises a ball-joint.

13. The roller-equipped guide of claim 3, wherein the guide roller is connected to the joint via a cantilever member.

14. The roller-equipped guide of claim 13 including two guide rollers connected together by a yoke, the joint being arranged at a first end of the cantilever member, which latter is connected by its second end to the yoke in a region situated between the two guide rollers.

15. The roller-equipped guide of claim 2 comprising two guide rollers which are connected together by a yoke, the joint being arranged on the yoke between the two guide rollers.

16. The roller-equipped guide of claim 5, wherein the guide rollers include a curved running surface.
